(19) United States
(12) Patent Application Publication
(10) Pub. No.: US 2014/0296384 A1
(43) Pub. Date: Oct. 2, 2014

(54) CORROSION, CHIP AND FUEL RESISTANT COATING COMPOSITION

(71) Applicant: 3M INNOVATIVE PROPERTIERS COMPANY, St. Paul, MN (US)

(72) Inventor: Suparno Hazra, Kolkata (IN)

(21) Appl. No.: 14/353,377

(22) PCT Filed: Oct. 25, 2012
(86) PCT No.: PCT/US2012/061778

§ 371 Date: Apr. 22, 2014

(30) Foreign Application Priority Data
Oct. 25, 2011 (IN) 3666/CHE/2011

(51) Int. Cl. C09D 5/08; C09D 133/12

(52) U.S. Cl. CPC C09D 5/08; C09D 133/12
USPC 523/437

(57) ABSTRACT

The present invention relates to a coating composition comprising an acrylic resin A with a glass transition temperature of 35° C. or higher and molecular weight of at least 35,000 g/mol; an acrylic resin B with a glass transition temperature of 57° C. or higher and a molecular weight of at least 60,000 g/mol; and an epoxy resin with a molecular weight of 3000 and hydroxyl equivalent of about 720 wherein the epoxy resin has been modified by cardanol to the ratio of 60:40.

### FIELD OF THE INVENTION

The present invention relates to coating compositions comprising acrylate-epoxy hybrid chemistries. More particularly, the coating compositions of the present invention can form coating films that afford excellent corrosion resistance, chip resistance and fuel resistance. Further, such coating systems are facilitated at low coating thickness with enhanced damping performance, through a highly conformable single pack coating. The coating composition of the present invention can adhere to primed or/and unprimed metal surfaces, is sprayable under wide ambient conditions and is curable in natural air drying conditions.

### BACKGROUND OF THE INVENTION

The underbody of a vehicle is frequently subjected to water from the road surface. Also hard and abrasive particles of grit or similar matter, together with water, especially salty water, make for a very harsh environment. Underbody structural components are typically coated to provide a first line of defense against corrosion. It is common practice to provide a coating to the metallic underbody of an automobile to protect the underbody from attack by road salt, water, and impinging road debris which cause rust and corrosion of the automobile underbody. Thus, underbody coatings are critical to automobile aesthetics (particularly that related to cabin acoustics), durability, resistance to chemical or physical impact and cost.

Conventionally, the underbody coatings used in the Service Industry (not in OEMs) are air drying, and single pack system. Most of the currently marketed products are Asphalt based, and have very limited performance parameters.

Many other underbody coatings having anti-corrosive, anti-abrasive and sound deadening properties are also well known in the prior art. For instance, US20020038615 provides a composition comprising an emulsion or dispersion of asphalt in water and fillers, wherein the asphalt emulsion on the surface of the substrate is exposed to a source of heat so as to dry the composition on the substrate. However, it has been seen that asphalt based products have no fuel resistance, low wear resistance and are also too sensitive to dirt cleaning solvents used in car garages when the car is serviced or repaired.

Some of the other serious disadvantages of the prior art asphaltic-type compositions is their tendency to become brittle, crack and separate from the substrate forming a pocket which can entrap corrosive salt water and keep it in contact with the metal substrate over an extended period of time.

Some of the other conventional underbody coatings, mainly being featured to be heat cured systems and targeted at offering sound damping characteristics have been discussed in WO20030478151, US20050051381, US20090292066, U.S. Pat. No. 6,559,193. Easily distinguished from the teachings of these conventional coatings, the coating composition as presently described in this invention can be air dried and offers superior fuel resistance and very high wear resistance.

Further, although most of the coating materials exhibit the basic requirements like anticorrosion property, there is always a shortfall of stringent OEM [Original equipment manufacturer] requirements such as superior anti chipping and anti-corrosive properties. It has been seen that although underbody coating products pass all the internal quality tests, certain problems are encountered with these coatings when subjected to very harsh durability conditions. For instance, it is a common practice that whenever an automobile is serviced or repaired, the vehicle is subjected to a diesel wash process wherein the cleaning is afforded by a water diesel mix to clear the dirt and grime from the underbody resulting in the softening of the underbody coating which eventually causes surface peeling and flaking of the coating. Moreover, the unstable viscosity under the prevalant application conditions result in sagging, overspray and a non-uniform coating. Therefore, these products are susceptible to failure under harsh treatment conditions. In view of the widespread use of these products, the significance attached to this problem is great, given the fact that the manufacturers of such coating compositions have warranty liabilities on durability failures of these products as a consequence of which they have to bear adverse economic costs.

A need exists, therefore, for superior underbody coating compositions that will eliminate or ameliorate disadvantages associated with the conventional compositions and also completely fulfill all requirements regarding efficacy of providing higher performance in terms of corrosion resistance, fuel resistance and abrasion/chip resistance, processability and applicability at economical costs.

By virtue of the present invention, the underbody coating composition for automotives so designed by the present inventors afford superior fuel resistance, superior abrasion/chip resistance and corrosion resistance. Additionally, the composition described in the present invention can be quickly dried, particularly under ambient conditions itself with superior adhesion to vehicle underbody substrates. The composition is designed to make available through a highly conformable single pack coating system a ready to use formula meeting varied market application practices.

### OBJECTIVE OF THE INVENTION

An object of the present invention is to provide a unique automotive underbody coating composition which meets simultaneously the following requirements:
Superior fuel resistance (diesel & gasoline).
Abrasion/chip resistance of high present standard at low film thickness.
Superior vibration damping property at low film thickness.
Quick drying characteristics under ambient conditions.
Superior adhesion to vehicle underbody substrates.
Ready to use formula meeting varied market application practices and
Extended life by corrosion protection.

The coating composition of the instant invention is based on acrylate-epoxy hybrid chemistries. The composition comprises acrylate polymer based fine particles varying between 10-50% by solids of the total formulation whose Tg (glass transition temperature) varies in the range of 45 to 100 degree centigrade and a modified epoxy resin wherein the epoxy resin percentage varies from 3-50% with respect to the total solution and having hydroxyl equivalent in the range of 600 to 800 and molecular weight of around 3000.

According to the present invention, the automotive underbody coating composition comprises a combination of two different acrylic resins having similar chemical functionalities but varying in glass transition temperature and molecular weights, a modified epoxy resin, one or more driers, one or more fillers, a rheological modifier additive, wetting & dispersing additive, a curing agent, a corrosion inhibitor and UV inhibitor.

Further scope of applicability of the present invention will become apparent from the detailed description given hereinafter. However, it should be understood that the detailed description and specific examples, while indicating embodiments of the invention, are given by way of illustration only, because various changes and modifications within the spirit and scope of the invention will become apparent to those skilled in the art from this detailed description. It is to be understood that both the foregoing general description and the following detailed description are exemplary and explanatory only and are not restrictive of the invention, as claimed.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1: Images of wear resistance

FIG. 2: Images of fuel resistance.

FIG. 3: Images of 1 mm cross hatch test.

FIG. 4: Impact test photos.

FIG. 5: Application photos.

FIG. 6: Pictoral representation of dissolution of coating in a competitor's test panel

### DETAILED DESCRIPTION OF THE INVENTION

In describing and claiming the invention, the following terminology will be used in accordance with the definitions set forth below. Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described herein. As used herein, each of the following terms has the meaning associated with it in this section. Specific and preferred values listed below for individual components, substituents, and ranges are for illustration only; they do not exclude other defined values or other values within defined ranges for the components and substituents.

As used herein, the singular forms “a,” “an,” and “the” include plural reference unless the context clearly dictates otherwise.

The use of numerical values in the various ranges specified in this application, unless expressly indicated otherwise, are stated as approximations as though the minimum and maximum values within the stated ranges were both preceded by the word “about”. Thus, slight variations above and below the stated ranges can be used to achieve substantially the same results as values within the ranges. Moreover, in the disclosure of these ranges, a continuous range is intended, covering every value between the minimum and maximum values, including the minimum and maximum end points of the range.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

Therefore, although it will be appreciated by those skilled in the art that the coating composition of the present invention may be applied to any type of metallic substrate, it is especially suited for use on preferably ferrous surfaces and will be described in connection therewith.

“Corrosion” is herein defined as an electrochemical process that seeks to reduce the binding energy in metals. It is a chemical or electrochemical reaction between a material, usually a metal, and its environment that produces a deterioration of the metal and its properties. The process of corrosion is as an anodic reaction process, whereby metal-dissolving ions are generated. The process occurring at the anodic site is the dissolution of metal as metallic ions, and converting these ions into insoluble corrosion products, such as rust.

The present composition is an acrylic resin based composition. Acrylics are known to have faster drying rates and superior mechanical strength compared to other single pack resin systems. In the present composition, two different acrylic resins having similar chemical functionality, but varying in the glass transition temperature and molecular weights are employed in this formulation.

Accordingly to one embodiment of the invention, the underbody coating composition of the present invention comprises a lower molecular weight Acrylic resin A, which constitutes one of the components with lower molecular weight of at least about 35,000g/mol and a glass transition temperature of at least 20° C. The acrylic resin A is a combination of at least two alkyl(meth)acrylate monomers selected from the group comprising methyl methacrylate, n-butyl methacrylate, iso-butyl methacrylate, ethyl methacrylate, propyl methacrylate, hexyl methacrylate, ethylhexyl methacrylate, 2-ethylehexyl methacrylate, cyclohexyl methacrylate, other aliphatic methacrylates, and combinations thereof. This thermoplastic resin is responsible for film formation at room temperature. This lower molecular weight resin with lower Tg (glass transition temperature) imparts flexibility to the thermoplastic film. This affords better vibration damping. The most preferred alkyl(meth)acrylate monomers for the combination that constitutes acrylic resin A includes, but is not limited to n-butyl methacrylate and methyl methacrylate combination.

The most preferred alkyl methacrylate monomer combination is n-butyl methacrylate and methyl methacrylate. For descriptive purposes, a chemical representation of n-butyl methacrylate and methyl methacrylate is disclosed below.

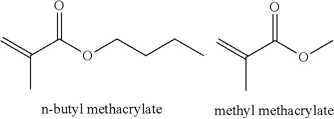

Preferably, the acrylic resin A is present in an amount of from 1-40 weight percent, more preferably from 1-20 weight percent, and most preferably about 9 weight percent based on the total weight of the composition.

According to another embodiment of the invention, the underbody coating composition of the present invention comprises a higher molecular weight Acrylic resin B, which constitutes one of the components with lower molecular weight of at least about 60,000g/mol and a glass transition temperature of about 35° C. to 90° C., preferably, the glass transition temperature is in the range of 57° C. The acrylic resin B is a combination of at least two alkyl(meth) acrylate monomers selected from the group comprising of methyl methacrylate, n-butyl methacrylate, iso-butyl methacrylate, ethyl methacrylate, propyl methacrylate, hexyl methacrylate, ethylhexyl methacrylate, 2-ethylehexyl methacrylate, cyclohexyl methacrylate, other aliphatic methacrylates, and combinations thereof. This thermoplastic resin is responsible for high strength film formation because of higher molecular weight and also provides higher wear resistance required for the application. The most preferred alkyl(meth) acrylate monomers for the combination that constitutes acrylic resin B includes, but is not limited to n-butyl methacrylate and methyl methacrylate combination.

Preferably, the acrylic resin B is present in an amount of from 1-30 weight percent, more preferably from 1-20 weight percent, and most preferably about 16 weight percent based on the total weight of the composition.

“Epoxy resins” are generally described by the type of central organic moiety or moieties to which the 1, 2-epoxy moieties are attached. Non-exclusive examples of such central moieties are those derived from bisphenol A, bisphenol F, novolak condensates of formaldehyde with phenol and substituted phenols, the condensates containing at least two aromatic nuclei; triazine; hydantoin; and other organic molecules containing at least two hydroxyl moieties each, in each instance with as many hydrogen atoms deleted from hydroxy moieties in the parent molecule as there are epoxy moieties in the molecules of epoxy resin. Optionally, the 1, 2-epoxy moieties may be separated from the central moieties as defined above by one or more, preferably only one methylene group. Oligomers of such monomers, either with themselves or with other organic molecules containing at least two hydroxyl moieties each, may also serve as the central organic moiety.

Non-exclusive examples of epoxy resins useful for the present invention include glycidyl ethers of a polyhydric phenol, such as bisphenol A (a particularly preferred species of polyhydric phenol), bisphenol F, bisphenol AD, catechol, resorcinol, and the like.

The acrylic resin A and B is employed in combination with an epoxy resin, which has been modified by cardanol obtained from CSNL (Cashew Nut Shell Liquid) resin to the ratio of 60:40.

Cardanol is a presently preferred alkenyl-substituted phenol. Cardanol is a meta-substituted phenol derived from cashew nut shell liquid. A general structural representation of cardanol is as provided below

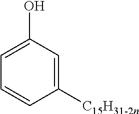

wherein, n is the number of carbon-carbon double bonds present in the alkenyl side chain and is typically 0,1,2 or 3. When more than one carbon-carbon double bond is present in the meta-positioned alkenyl chain, the carbon-carbon double bonds may be conjugated or non-conjugated. It is contemplated that compounds having the above generalized structure may be employed to modify the epoxy resin.

Preferably, the Epox resin has a molecular weight of 3000 and hydroxyl equivalent of about 720. The Epox imparts excellent adhesion to metal because of the free hydroxyl groups, gives good flexibility to the system and provides superior chemical resistance. The Epox resin is preferably an epoxy ether resin.

Preferably, the epoxy resin is present in an amount from 1-30 weight percent, more preferably from 1-20 weight percent, and most preferably about 14 weight percent based on the total weight of the composition.

The composition comprises an additives selected from the group comprising a drier, dispersing agent, filler, rheological modifier additive and solvent.

Drier combination is used to accelerate the conversion of coating from liquid form to dry film. By the term “drier” herein is meant a siccative, that is by “drier” is meant any metal salts of higher aliphatic acids having from 8 to 30 carbon atoms or of naphthanic acids that primarily behave as an oxidation catalyst. Driers are heavy metal soaps of organic acids. Examples of the polyvalent metal include calcium, cobalt, copper, manganese, lead, iron, vanadium and the like. Non-limiting examples of preferred drier combinations are selected from the groups comprising cobalt naphthanate, calcium naphthanate, nickel naphthanate, manganese naphthanate, nickel octoate, cobalt octoate, zirconium octoate or combinations thereof.

Some of the most preferred drier combinations employed in context of the present invention are selected from the group comprising:
1. Cobalt Naphthanate: Acts as a “surface drier”. It is primarily an oxidation catalyst and has a tendency to cause surface wrinkling, hence to provide uniform drying.
2. Calcium Naphthanate: Acts as an cross-linking agent and improves hardness of dried film as well as its adhesions.

In one of the embodiments of the present invention the drier combination is present in the composition of the present invention in an amount of upto 5 weight percent, or in some cases upto 4 weight percent, or in some cases 3 weight percent with the weight percent being considered based on the total weight of the composition Preferably, in order to appreciate the advantageous attributes of the present invention, the anti-corrosive composition comprises about 0.1 to 1 weight percent of the drier combination based on the total weight of the composition.

According to one aspect of the invention, the composition of the present invention comprises a wetting and dispersing agent. The dispersing agent is a solution of a salt of unsaturated polyamine amides and lower molecular weight acidic polyesters. It acts as a dispersing agent which helps in dispersing the fillers in the total system homogenously. This is the primary role of the dispersing agent which is to enhance the dispersion process and ensure a fine particle size in order to stabilize pigments in the binder solution. Preferably in context of the present invention the wetting and dispersing additive is AntiTera U/Byk 9056.

Accordingly, the dispersing agent is present in the composition of the present invention in an amount of upto 5 weight percent, or in some cases upto 4 weight percent, or in some cases 3 weight percent with the weight percent being considered based on the total weight of the composition. Preferably, in order to appreciate the advantageous attributes of the present invention, the anti-corrosive composition comprises about 0.1 to 5 weight percent of the dispersing agent based on the total weight of the composition.

The wetting step consists of replacing the adsorbed materials on the surface of the pigment/filler and inside the agglomerates (water, oxygen, air) by the binder solution.

The complete wetting out of pigment/filler helps to enhance the technical performance of a liquid coating that depends very much on interaction between the pigment particles and the binder system. Dispersing additives, which absorb on the pigment surface, facilitate liquid/solid interfacial interactions and help to replace the air/solid interface by a liquid medium/solid interface.

Fillers: Inorganic fillers are solids that are present in a finely divided form in the composition. Fillers have two tasks; on the one hand they are to bring down the cost of a product in the conventional sense and ensure that, in comparison with products that are not filled, it has improved or additional properties like hiding strength, coverage etc. Non-limiting examples of suitable inorganic fillers are finely divided calcium carbonates (e.g. heavy calcium carbonate, precipitated calcium carbonate, surface-treated calcium carbonate, etc.) ground silica, fumed silica, precipitated silica, silicic anhydride, talc, clay, magnesium carbonate, black oxide, titanium oxide, casting plaster, barium sulfate, zinc oxide, mica powder, bentonite, glass powder, red iron oxide, carbon black, graphite powder, alumina either alone or in one or combinations thereof. The most preferred fillers employed in the present composition include calcium carbonate, black oxide and talc. Preferably each of these individual fillers are employed in the composition in the range of about 2-5 weight percent based on the total weight of the composition.

Calcium carbonate employed as filler in the current composition increases the hiding power of the coating and gives mass to the total system, whereas talc helps to promote the anti-corrosive property of the system. Black oxide imparts color and UV resistance properties.

Preferably the amount of filler in the composition is about 2 percent by weight or greater and more preferably 5 percent by weight or greater. Preferably the amount of filler in the composition is about 1 to 10 weight percent based on the total weight of the composition to achieve the desired workability of the composition.

In the formulation of coatings, it is well-known that rheological modifiers may be added to control the flow properties of the final product for a particular application. The rheological modifier utilized in the improved coating composition of the present invention advantageously performs the functions of both an anti-sag additive as well as a flow control agent.

The rheological additive of the present invention improves the sag resistance of a coating composition. Following application on a surface, the coating must maintain sufficient viscosity during the drying process to prevent unsightly runs and drips until the coating is dry. The most preferred rheological modifier/additive employed in context of the present invention is Aerosil. Aerosil that is used in the present composition helps to build thixotropicity in the system and also stabilizes the total system, preventing settling and agglomeration.

Preferably the amount of rheological modifier additive in the composition is about 1-5 percent by weight and more preferably 2 percent by weight or greater. Preferably the amount of filler in the composition is about 1 to 10 weight percent based on the total weight of the composition to achieve the desired workability of the composition.

The composition of the present invention comprises rubber. Rubber helps to provide better sound damping properties, helps in creating the texture to be in compliance with market standards, and also acts as a filler to some extent. Preferably the amount of rubber in the composition is about 1-10 percent by weight and more preferably about 7 percent by weight or lesser and most preferably about 0.1 to 2 percent by weight based on the total weight of the composition.

Exemplary solvents/diluents include but are not limited to xylene, toluene, butyl acetate, acetone, methyl ethyl ketone, methyl isobutyl ketone, alcohols such as methanol, ethanol, propanol, butanol, diacetone alcohol or other aromatic hydrocarbon solvents, alcohols or mixtures thereof.

Most preferred solvents in context of the present invention, include, but are not limited to xylene, toluene and diacetone alcohol. The solvent is used to offer coatability and adhesion property.

More specifically, toluene is employed as a solvent so as to afford faster drying and to optimize the drying time whereas Xylene as a solvent enables slower drying when compared to toluene and also prevents choking of the spray gun tip. Di acetone alcohol is mainly employed to adjust polarity for the aerosil to be functional.

In the composition of the present invention the solvent is present in an amount, based on the total weight of the composition, of from 20 to 80 weight %, more preferably from 40 to 60% and most preferably about 50%.

The coating compositions are conventionally applied onto substrates, in particular metal substrates, such as vehicle bodies, which have optionally been pre-coated e.g. with a primer. These in particular comprise metals as are used for the production of vehicle bodies such as steel.

The present invention provides an improved underbody coating compositions which may be easily applied by conventional spraying systems. Other modes of application are roller coating, brushing, sprinkling, flow coating, dipping, electrostatic spraying and the like.

Compositions of the present invention can be applied to a substrate to be treated by conventional coating techniques such as, for example, spray coating, brush coating, dip coating, direct roll coating, reverse roll coating, curtain coating, and combinations thereof, among other methods. Preferably, compositions of the present invention are applied by a paint spray gun.

Compositions of the present invention may be applied as a single coating, for example, as a topcoat as a basecoat in a two-coat composition; or as a layer of a multi-component coating, for example, as a primer layer, basecoat and/or topcoat layer. Compositions of this invention are useful, for example, as a primer, a basecoat and/or a topcoat, applied either directly onto the substrate surface itself or disposed onto prior underlying coating(s) and/or treatment(s), e.g., an inorganic or organic treatment, a primer, and/or basecoat material, disposed on the substrate surface to achieve a desired result.

In a preferred embodiment of the present invention, the underbody coating composition comprises at least
(a) At least about 9 wt % of acrylic resin A of n-butyl methacrylate/methyl methacrylate combination of M_{w}=35,000 g/mol and T_{g}=51° C.
(b) At least about 16 wt % of acrylic resin A of n-butyl methacrylate/methyl methacrylate combination of M_{w}=60,000 g/mol and T_{g}=57° C.
(c) At least about 14 wt % of epox
(d) At least about 0.50 wt % of an dispersing agent
(e) At least about 6.0 wt % of filler
(f) At least about 1 wt % of rheological additive
(g) At least about 50 wt % of solvent
(h) At least about 0.1 wt % of drier
The weight percentages are based on the total weight of the composition.

In addition to the aforementioned components, the instant compositions may optionally contain effective amounts of known additives, including but not limited to: corrosion inhibitors, dyes, curing agents, fragrances, ultraviolet light absorbers; antifoaming agents: antistatic agents; thickening agents (e.g., xanthan gum, cellulose, methylcellulose, pectin and the like). These optional components may be effectively added to modify the appearance, smell or provide an additional property to the composition by addition of an optional additive possessing a known performance property.

According to a further aspect of the invention a test metal panel coated with a composition as per the current invention were subjected to various tests to evaluate the parameters such as oil resistance, boiling water resistance, Impact resistance, agening resistance, corrosion resistance, wear resistance, damping properties, diesel resistance and adhesion.

The oil resistance of coatings is tested by partial or complete immersion of coated test specimens in oil at elevated temperatures. Subsequently, the test metal panel is checked for softening, blistering or peeling of the coating composition.

The water resistance of coatings is tested by partial or complete immersion of coated test specimens in distilled or de-mineralized water at elevated temperatures. Although the apparatus and procedure could be employed in immersion tests using solutions of various materials in water, this practice is limited to tests in water alone.

Coated specimens are partially or wholly immersed in water in a container that is resistant to corrosion. The exposure conditions are varied by selecting (a) the temperature of the water and (b) the duration of the test. Water permeates the coating at rates that are dependant upon the characteristics of the coating and upon the temperature of the water. Any effects such as color change, blistering, loss of adhesion, softening or embrittlement are observed and reported.

The impact resistance of the test panel is tested by dropping a load of 500 gm wt, of 0.5 inch diameter from a height of 500mm, on the metal test panel coated with the coating composition of the present invention.

Corrosion resistance test is conducted on a metal test panel and a coating of the composition prepared in accordance with the current invention. More specifically the corrosion resistance test is the salt spray test. The salt spray test is a standardized test method used to check corrosion resistance of coated samples. The appearance of corrosion products is evaluated after a period of time. Test duration depends on the corrosion resistance of the coating; the more corrosion resistant the coating is, longer the period in testing without showing signs of corrosion.

More particularly this test method covers the treatment of previously painted or coated specimens for accelerated and atmospheric exposure tests and their subsequent evaluation in respect to corrosion, blistering associated with corrosion, loss of adhesion at a scribe mark, or other film failure. This method therefore provides a means of evaluating and comparing basic corrosion performance of a substrate, pretreatment or coating system or combination thereof, after exposure to corrosive environments.

The composition of the present invention is subjected to a diesel resistance test to assess the diesel resistance of the coating composition.

In order to assess the adhesion of coating films to metallic substrates by subjecting to 1mm cross hatch test. These test methods are used to establish whether the adhesion of a coating to a substrate is at a generally adequate level.

The invention is further illustrated in the Examples section which follows. This section is set forth to aid in an understanding of the invention but is not intended to, and should not be construed to, limit in any way the invention as set forth in the claims which follow thereafter.

### EXAMPLE 1

Example 1 illustrates embodiments of the underbody coating composition of the present invention. Formulation 1 tabulated in table 1 is an embodiment of coating composition of the present invention. The underbody coating composition was prepared in accordance to the tabulated components in Table 1.

TABLE 1

| Components | Ingredients | Weight by % |
|---|---|---|
| 1 | Acrylic Resin A | 9 |
| 2 | Acrylic Resin B | 16 |
| 3 | Epox | 14 |
| 4 | Drier | 0.10 |
| 5 | Dispersing Agent | 0.50 |
| 6 | Talc | 2 |
| 6 | Aerosil | 01.4 |
| 7 | Black Oxide | 02.00 |
| 9 | Calcium Carbonate | 2 |
| 10 | Toluene | 11.00 |
| 11 | Di acetone Alcohol | 5.0 |
| 12 | Xylene | 35.00 |
| 13 | Mixed rubber | |
| a | Reclaimed rubber | 1.5 |
| b | Butyl Rubber | 0.5 |
| | Total | 100.00 |

### EXAMPLE 2

The whole composition was prepared under mechanical stirring, at room temperature of 25° C. to 30° C. The RPM was adjusted during the mixing stage, and after addition of all the ingredients was stirred at high speed of 3500 RPM for 3-5 minutes for complete dispersion of the fillers and attainment of the desired thixotropy.

Both the rubber 13 a and b were taken in required proportion and mixed in a two roll mill thoroughly at room temperature to make a homogenous mixture. The weighed amount of mixed rubber (13 a and b) was dissolved in weighed amount of toluene (12) for complete swelling and kept immersed for 12 hours. The swelled rubber was subsequently stirred at 1000-1500 rpm to make a paste. Weighed amount of solvent (10 & 11) were taken in the mixing vessel. Required amount of resin A(1) and B(2) was weighed. The resin was added to the solvent slowly under continuous stirring at 500-1000rpm, for 10-15 min. Subsequently the speed was increased to 1500-2000 rpm to ensure full dissolution. Dispersing agent (5) was added to the stirring solution. Weighed amount of fillers (6.8 and 9) was added to the stirring mixture and the RPM was increased to 2500 for uniform dispersion. After 5 min, RPM was reduced to 500 and weighed amount of epoxy (3) was added under stirring. RPM was increased to 1500. The weighed amount of drier (4) was added. The rubber paste (13) made in step 2 was added subsequently by lowering the RPM to 500, RPM was increased to 2000 and allowed to mix thoroughly for 5 minutes. Finally, the RPM was lowered to 500 and Aerosil (7) was added to the solution. After complete dissolution of the powder, the speed was increased to 3500 rpm, for 3-5 minutes, for final dispersion and attainment of the required thixotropy and viscosity.

### EXAMPLE 3

Oil Resistance Test

The coating composition prepared in accordance to the current invention were applied at uniform thickness to test metal panels and were subjected to 3 hour immersion in gear oil for 3 hours at 50° C. The composition exhibited good resistance to oil as the test metal panel coated with the composition of the present invention was free from softening, blistering and peeling off.

### EXAMPLE 4

Boiling Water Resistance Test: The coating composition prepared in accordance to the current invention were applied at uniform thickness to test metal panels and the tank was filled with water to a depth such that the test specimens were immersed approximately three quarters of their length. The test panels were subjected to 30 minutes immersion of coated panel in boiling water. The composition exhibited good resistance to water as the test metal panel coated with the composition of the present invention was free from softening, blistering and peeling off.

### EXAMPLE 5

Impact Resistance Test:

The coating composition prepared in accordance to the current invention were applied at uniform thickness to test metal panels and subjected to drop impact test of 500 gm weight, of 0.5 inch diameter from a height of 500 mm, on the reverse side of the panel. The composition of the present invention was free from peeling off.

### EXAMPLE 6

Ageing Resistance

The coating composition prepared in accordance to the current invention were applied at uniform thickness to test metal panels and subjected to 80° C. for 6 days and then at −40° C. for 2 days, subsequently at 55° C. and 95% RH for days and again at −40° C. for 2 days and 80° C. for 3 days. The panel was checked for wear resistance after the treatment. The composition of the present invention passed 18 kg of nut drop resistance after the cycle.

### EXAMPLE 7

Corrosion Resistance Test The test was performed in an apparatus for testing consisting a closed testing chamber, where a salted solution (mainly, a solution of sodium chloride) was atomized by means of a nozzle. This produces a corrosive environment of dense saline fog in the chamber such that the metal parts exposed were attacked under accelerated corroding atmosphere.

The metal test piece uniformly coated with the composition of the present invention was exposed to standardized 5% solution of NaCl known as NSS (neutral salt spray). The results are represented as testing hours in NSS without appearance of corrosion products. The current invention is tested to pass 600 hrs of Salt Spray Test.

### EXAMPLE 8

Wear Resistance Test

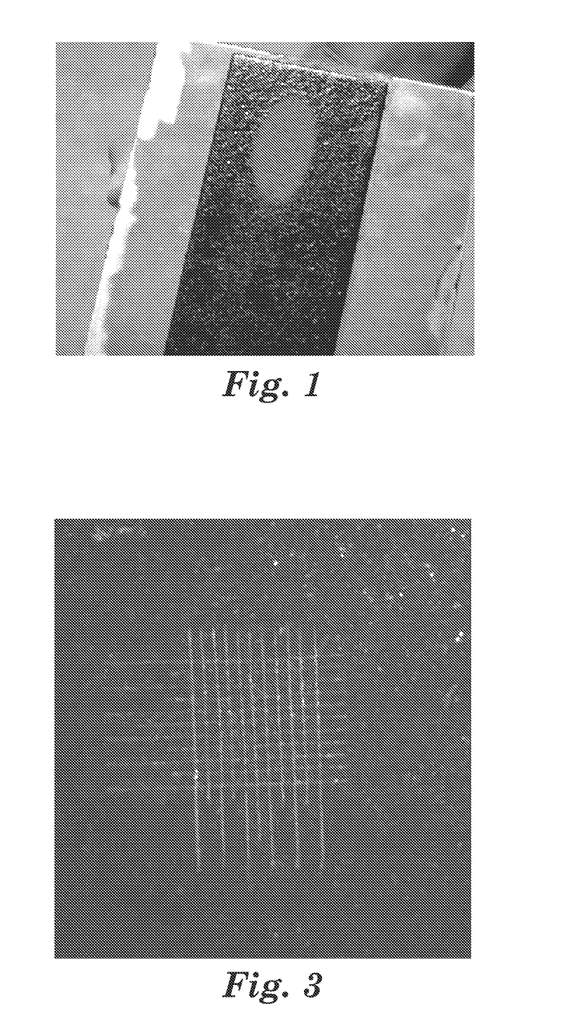

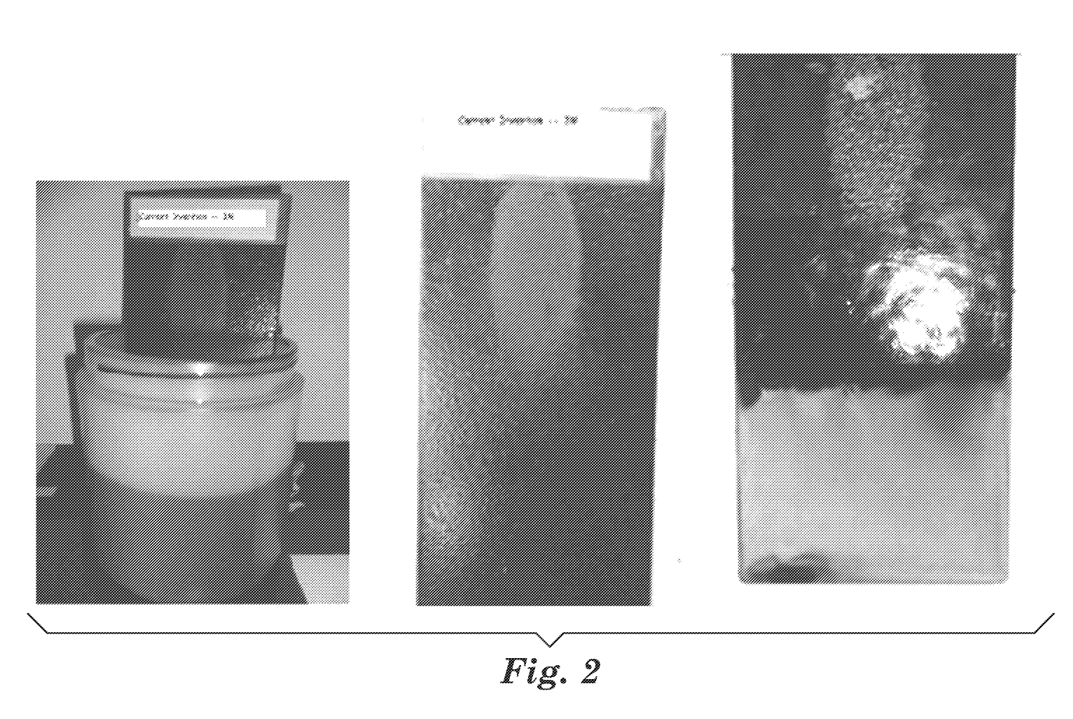

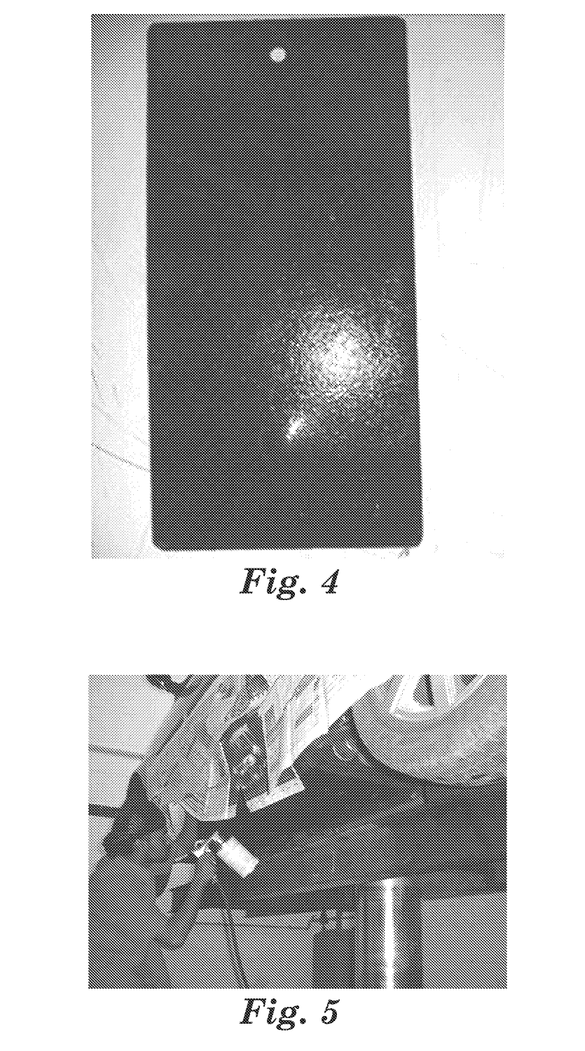

The coating composition prepared in accordance to the current invention were applied at uniform thickness to test metal panels and the wear resistance of the coating composition was checked by dropping a 3mm hexagonal brass nut dropped from a height of 2 metres at an angle of 45° C. The test panel coated with the composition of the present invention passed 21 kgs of nuts dropped which is far superior to the currently marketed products which fail at this test at merely 2-5 kgs. A pictoral representation of the wear resistance exhibited by the present composition is shown in FIG. 1.

### EXAMPLE 9

Damping Properties

The damping properties of the present composition is checked in a panel of size 7.5 cm*150 cm, by using Impact hammer The damping co-efficient was found to be 0.06-0.08 at a coating thickness of 450 micron.

### EXAMPLE 10

Diesel Resistance Test

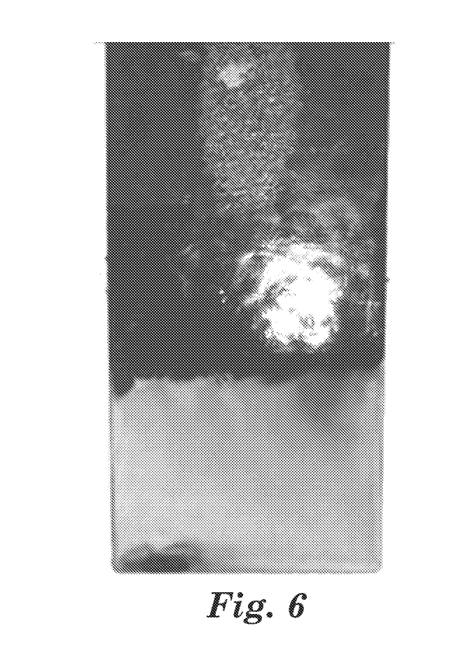

The coating composition prepared in accordance to the current invention was applied at uniform thickness to test metal panels and were subjected to 12 hour immersion in diesel. The composition exhibited good resistance to diesel as the test metal panel coated with the composition of the present invention was free from softening, blistering and peeling off. However, most of the currently marketed products show softening of the coating in contact with Diesel. If prolonged for 15 min, the whole of coating is dissolved from the competitors test panel. (As provided in FIG. 6)

### EXAMPLE 11

Adhesion Test

The procedure comprises for assessing the adhesion of coating films to metallic substrates by applying and removing pressure-sensitive tape over cuts made in the film. The coating composition prepared in accordance to the current invention were applied at uniform thickness to test metal panels and were subjected to 1mm cross hatch test. No peeling off was observed.

Table 2 tabulates the comparative performance of the coating composition of the present invention vis-à-vis the marketed product.

TABLE 2

| Sl. | | Current | Conventional Test | |
|---|---|---|---|---|
| No | Test | Invention | Product | Remarks |
| 1 | Oil Resistance | Pass | Pass | |
| 2 | Boiling water | Pass | Pass | |
| | resistance | | | |
| 3 | Impact | Pass | Fail | High |
| | resistance | | | performing |
| 4 | Wear resistance | Passed 21 Kgs | Failed less than | High |
| | | | 3 kg | performing |
| 5 | Damping | 0.04 to 0.06 | 0.03 to 0.04 | High |
| | performance | | | performing |
| 6 | Diesel resistance | Passed | Passed 24 hours | |
| | | 24 hours | | |
| 7 | Cross Hatch | Pass | Fail | High |
| | (1 mm) | | | performing |

A person skilled in the art will be able to practice the present invention in view of the description presented in this document, which is to be taken as a whole. Although the foregoing invention has been described in some detail by way of illustration and example for purposes of clarity of understanding, one of skill in the art will appreciate that certain changes and modifications may be practiced within the scope of the appended claims. Numerous details and examples have been set forth in order to provide a more thorough understanding of the invention. While the invention has been disclosed in its preferred form, the specific embodiments and examples thereof as disclosed and illustrated herein are not to be considered in a limiting sense. It should be readily apparent to those skilled in the art in view of the present description that the invention can be modified in numerous ways. The inventor regards the subject matter of the invention to include all combinations and sub-combinations of the various elements, features, functions and/or properties disclosed herein.

1. A coating composition comprising
(a) an acrylic resin A with a glass transition temperature of 35° C. or higher and molecular weight of at least 35,000 g/mol
(b) an acrylic resin B with a glass transition temperature of 57° C. or higher and a molecular weight of at least 60,000 g/mol.
(c) an epoxy resin with a molecular weight of 3000 and hydroxyl equivalent of about 720 wherein the epoxy resin has been modified by cardanol to the ratio of 60:40.

2. The coating composition as claimed in claim 1, wherein the acrylic resin A is selected from the group comprising at least two alkyl(meth)acrylate monomers selected from the group comprising of methyl methacrylate, n-butyl methacrylate, iso-butyl methacrylate, ethyl methacrylate, propyl methacrylate, hexyl methacrylate, ethylhexyl methacrylate, 2-ethylehexyl methacrylate, cyclohexyl methacrylate, other aliphatic methacrylates, and combinations thereof.

3. The coating composition as claimed in claim 2, wherein the acrylic resin A comprises a combination of methyl methacrylate and n-butyl methacrylate.

4. The coating composition as claimed in claim 1, wherein the acrylic resin B is selected from the group comprising at least two alkyl(meth)acrylate monomers selected from the group comprising of methyl methacrylate, n-butyl methacrylate, iso-butyl methacrylate, ethyl methacrylate, propyl methacrylate, hexyl methacrylate, ethylhexyl methacrylate, 2-ethylehexyl methacrylate, cyclohexyl methacrylate, other aliphatic methacrylates, and combinations thereof.

5. The coating composition as claimed in claim 4, wherein the acrylic resin B comprises a combination of methyl methacrylate and n-butyl methacrylate.

6. The coating composition as claimed in claim 1, wherein the acrylic resin A is present in an amount from 1-20 weight percent based on the total weight of the composition.

7. The coating composition as claimed in claim 1, wherein the acrylic resin B is present in an amount from 1-30 weight percent based on the total weight of the composition.

8. The coating composition as claimed in claim 1, wherein the epoxy resin is present in an amount from about 1-30 weight percent based on the total weight of the composition.

9. The coating composition as claimed in claim 1, wherein the composition comprises an additive selected from the group comprising a drier, dispersing agent, filler, rheological modifier additive, rubber and solvent.

10. The coating composition as claimed in claim 9, wherein the drier is selected from the group comprising cobalt naphthanate, calcium naphthanate, nickel naphthanate, manganese naphthanate, nickel octoate, cobalt octoate, zirconium octoate or combinations thereof.

11. The coating composition as claimed in claim 9, wherein the drier is calcium naphthanate.

12. The coating composition as claimed in claim 9, wherein the drier is present in an amount from 0.1-5 weight percent based on the total weight of the composition.

13. The coating composition as claimed in claim 9, wherein the dispersing agent is Antitera U.

14. The coating composition as claimed in claim 9, wherein the dispersing agent is present in amount from 0.1-5 weight percent based on the total weight of the composition.

15. The coating composition as claimed in claim 9, wherein the filler is selected from the group comprising calcium carbonates, ground silica, fumed silica, precipitated silica, silicic anhydride, talc, clay, magnesium carbonate, black oxide, titanium oxide, casting plaster, barium sulfate, zinc oxide, mica powder, bentonite, glass powder, red iron oxide, carbon black, graphite powder, alumina or combinations thereof.

16. The composition as claimed in claim 9, wherein the filler is present in amount from 1-10 weight percent based on the total weight of the composition.

17. The composition as claimed in claim 9, wherein the rheological modifier additive is Aerosil.

18. The composition as claimed in claim 9, wherein the rheological modifier additive is present in amount from 1-10 weight percent based on the total weight of the composition.

19. The composition as claimed in claim 9, wherein the solvent is selected from the group comprising xylene, toluene, butyl acetate, acetone, methyl ethyl ketone, methyl isobutyl ketone, alcohols such as methanol, ethanol, propanol, butanol, diacetone alcohol or other aromatic hydrocarbon solvents, alcohols or mixtures thereof.

20. The composition as claimed in claim 9, wherein the solvent amount to 20-80 weight percent based on the total weight of the composition.

21. (canceled)
